(19) United States
(12) Patent Application Publication
(10) Pub. No.: US 2015/0316452 A1
(43) Pub. Date: Nov. 5, 2015

(54) Apparatus and Method For Conditioning a Fluid Sample

(71) Applicant: Nathan E. Progar, Chalfont, PA (US)

(72) Inventor: Nathan E. Progar, Chalfont, PA (US)

(73) Assignee: PROEM TECHNOLOGY COMPANY, Chalfont, PA (US)

(21) Appl. No.: 14/269,556

(22) Filed: May 5, 2014

(51) Int. Cl. G01N 1/28

(52) U.S. Cl. CPC G01N 1/28

(57) ABSTRACT

The present invention as described herein provides a means to remove water vapor, entrained condensable liquids, and entrained condensable solids from an environmental fluid sample to prepare the vapor and/or condensate fractions of such fluid sample for chemical analyses. It substantially reduces equipment breakage risk from the fragile equipment required to be used in the current art, reduces differential pressure across the sample preparation system, avoids changes in chemical composition of the vapor and liquid samples while allowing direct analysis of the condensate stream or streams, allows for operation in a wider sample stream vacuum or pressure ranges, and reduces required maintenance downtime.

### BACKGROUND

1. Field of the Invention

Environmental vapor sample preparation systems remove condensable liquids, primarily water vapor and moisture, from acquired vapor or air samples during, quality control evaluation, performance specification testing or continuous emission monitoring chemical analysis.

The current invention allows the complete collection of separate liquid and vapor samples by condensing the sample without the use of sacrificial impinger agents, such as silica gel, commonly used in performance specification testing methods specified by the United States Environmental Protection Agency. The present invention also decreases maintenance requirements, optimizing operating time. The present invention can be finely calibrated to remove condensable materials at adjustable temperature settings.

2. Description of the Related Art

Existing sample preparation systems, that condition samples for analysis by removing moisture in excess of tolerances for testing, such as 40 CFR 60, Appendix A-4, Method 8, typically require a series of fragile glass impingers containing various chemicals placed in an ice bath, which require additional equipment to be used in the sample train, provide inconsistent moisture removal, increase the likelihood of sample train leaks, increase the pressure required to transfer the sample through the preparation system, and, in some cases, can change the chemical composition of the vapor sample. Performance specification test equipment typically must be either transported long distances between locations where analyses must be performed, operated in severe operating environments, or both. Glass impingers are fragile, and frequently break or otherwise fail en route to the sampling location or during sample acquisition. Because impingers include a number of glass to glass connections, sample air leaks are common, delaying testing and possibly invalidating tests that may require a several hour sample acquisition cycle to meet Environmental Protection Agency requirements.

The impingers used in the current art contain various materials, such as added water and silica gel, which can remove some of the environmental materials of interest in the sampling protocol, reducing the accuracy of the analytical instruments used downstream of the sample preparation system to evaluate vapor stream constituent concentrations and depriving the owner or operator of the sampled stream full analysis of the stream being sampled. Impinger methods are impractical for use during continuous testing. As described above, impinger methods require significant hands-on maintenance not typically available in continuous or batch production environments subject to emissions monitoring requirements.

Solid impingers like that described in U.S. Pat. No. 8,475,565 by Smith and U.S. Pat. No. 8,211,210 by Smith have been developed, but lack the ability to separate condensed liquids from vapor streams and lack the ability to be configured for specific sampling stream requirements. Separation chambers described in U.S. Pat. No. 4,678,488 by Howard and Stedman have also been used to remove condensable liquids from gas streams, but lack the precise temperature controls required to properly condition gas samples to specified levels of moisture. In applications where specific chemical compounds may be condensable at a given temperature, an owner of an emissions process may wish to precisely set the temperature at which condensation occurs to better facilitate collecting samples with specific chemical compositions. Such chemical separation is not feasible in the existing art.

Centrifugal separators were taught in U.S. Pat. No. 8,128,731 by Mashimo, but the forces required to separate condensable materials from the vapor stream, in addition to the air exchange within and outside of a centrifugal separator, can dilute the desired vapor sample, creating unacceptable inaccuracy in analytical results. Filters are available to condition vapor streams as taught in U.S. Pat. No. 8,252,080 by Fudge et. al., but cannot be used for this purpose because of interference with filtration based methods to analyze particulate matter in sample streams. Scrubber and dryer systems were taught in U.S. Pat. No. 7,964,017 by Petinarides, but would change the nature and quality of the sample stream. Membrane systems were taught in U.S. Pat. No. 6,701,794 by Mayeaux, but change the nature of the sample and are suspect to fouling, requiring significant maintenance.

The present invention differs from the venturi dew point method taught by Patent Application 2012-0133942 by Lonigro and Chloat in that, while some analyses require entrained vapors to be delivered to the analyzer, others require that the entrained liquids be removed and possibly sampled separately, and in some situations the liquids are simply removed and disposed of. It also differs from the method taught in Patent Application 2011-0303024 by Wallis et. al., which relies on countercurrent flow to manage an ambient air sample, lacking the ability to isolate the discrete sample required by methods using the invention disclosed herein.

Cold plates are used in other environmental areas to solve a variety of other challenges. U.S. Pat. No. 6,378,311 by McCordic teaches a method to dehumidify air in enclosed spaces using a cold plate, where the method taught does not concern itself with the fine controls required to recover the entire fluid and any entrained particles being condensed, nor does it teach methods to optimize condensation within the cold plate system. Patent Application 2013-0250519 by Zaffetti and Taddey teaches a honeycomb sample chilling method, not usable for systems like this invention where collection of discrete fluid samples is required. U.S. Pat. No. 8,544,294 by Garner teaches a plate-based adsorption chiller system that does not optimize condensed liquid sample collection for further analysis. U.S. Pat. No. 8,250,879 by MacBain and Stark teaches a two-pass cold plate system that does not facilitate optimal condensate collection.

The present invention includes a tortuous condensation path that optimizes collection of entrained liquids and condensable particulates in the separation system while avoiding extensive aliquot collection, sample chemical reaction, and extensive mass balance evaluations required of existing testing methods. The present invention allows for one-step mass balance evaluations of the liquid condensate and vapor phases for evaluating emissions. Unlike current testing methods, the present invention allows proper moisture and condensate management in real time sampling systems that may remain in long term service not previously achieved in practice. The present invention can be customized to operate in sampling systems operating at different pressures, to obtain liquid and vapor separation at vacuum or under pressure when the stream to be sampled is available at a pressure other than ambient. The existing art operates almost exclusively at ambient pressure or at vacuum. Because the present invention lacks the delicate glassware and consumable materials common to Environmental Protection Agency performance specification testing methods, it may be used to condition samples to be analyzed by real time continuous monitoring systems without human attention under a wide range of operating pressure or vacuum. Because it has these elements, the present invention allows for improved real time and performance specification testing sample conditioning and complete analyses of the liquid condensate stream as it is collected from the sample conditioner.

### BRIEF SUMMARY OF THE PRESENT INVENTION

The present invention is a sample conditioning preparation system placed inline in a vapor sample system, consistently removing water vapor and moisture from the sample while minimizing leaks, minimizing pressures required to obtain and condition the sample, minimizing maintenance downtime by eliminating static or moving maintenance parts and providing for easy cleaning, while appropriately capturing and collecting any particles or aerosols in the vapor stream, without changing the chemical composition of the sample. The present invention allows sample conditioning not only during periodic short term performance specification testing, but allows for sample conditioning during normal operation of continuous emissions monitoring systems. The invention conditions the sample by passing the sample through a plurality of temperature controlled heat exchange plates via a serpentine or tortuous path, providing an orifice to separate condensed water droplets from the sample stream if needed, and a separation chamber to remove separated liquid droplets and entrained particles from the sample stream, routing the remaining vapor sample for further analysis, and routing the condensed liquids to an outlet for further analysis if required or removal.

Service ports may be included to provide maintenance and cleaning access at each entry and exit port, as well as at the separation orifice. Pressure regulation may be applied at the entry and exit ports to adapt the system to pressurized sample streams or sample streams under vacuum. The heat exchange plate is maintained at an appropriate temperature by one of several means, including circulating a temperature control fluid through one or more additional channels in the cold plate system or fastening a plurality of heat exchange apparatus to a plurality of faces of the conditioner heat exchange block. Operating temperature is monitored by a temperature sensing system, either monitoring vapor stream outlet temperature, liquid condensate temperature, and/or heat exchange block temperature. Multiple assemblies can be operated in series to manage condensation collection as a function of the temperature set point of each plate, or parallel to accommodate larger sample volumes or samples to be taken at different temperature set points.

### BRIEF DESCRIPTION OF THE DRAWINGS

FIG. 1 shows an overhead view of the sample preparation system.

FIG. 2 shows a profile view of the inlet and vapor outlet section of the sample preparation system, as well as the mounting of the typical embodiment of a heat transfer system to a cold plate surface.

FIG. 3 shows a profile view of the liquid outlet section of the sample preparation system.

FIG. 4 shows a profile view of the nozzle access port.

### DETAILED DESCRIPTION OF THE INVENTION

The present invention is a vapor sample preparation system and a method to remove condensable matter, including water vapor, moisture, condensable liquids, and condensable entrained particles, from vapor samples, to prepare environmental vapor samples for chemical analysis. The sample preparation system comprises a heat exchange plate system, operating as a cold plate system, including a length of channel where the vapor sample travels.

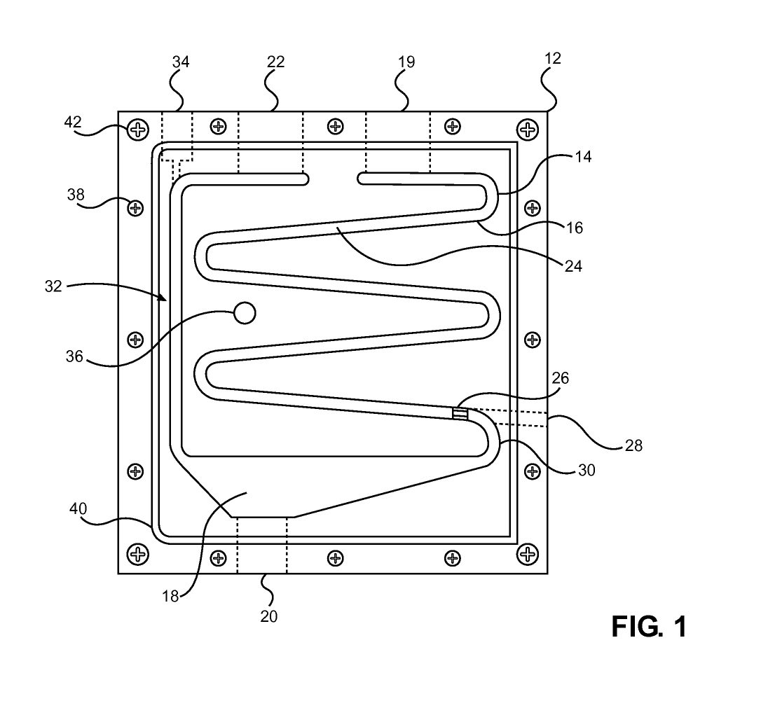

Referring now to FIG. 1, the plate system contains one sample inlet point 19 for unconditioned sample entry into the thermally conductive cold plate 12, a tortuous, typically milled, lined with protective coating or including sample conveying tubing if needed to protect the cold plate, sample path 14 to optimize condensation in the apparatus, with sufficient downward slope angle to collect condensate 16. A higher volume condensate dropout cavity collects condensed liquid 18, which flows into the sample outlet point for collection and removal of condensed liquids for either further analysis or disposal 20. Vapors travel to the vapor sample outlet port for conditioned sample exit en route to other analytical equipment 22 at a point in the system at a higher elevation than the highest elevation condensate dropout cavity.

The sample channel is of sufficient dimensions to allow for sample travel while minimizing the differential pressure in the channel 24. Appropriate dimensions also optimize sample contact time with the cold plate for adequate heat transfer from the sample to allow moisture and water vapor to condense into water droplets without interfering with sample flow. At the end of the sample channel, a flow restriction, typically in the form of an orifice or nozzle 26 with one or more service access ports 28 may be used to mechanically collect the condensed water droplets from the channel, coalescing the droplets into either larger droplets or into a liquid stream and completing the separation of the condensed water droplets from the vapor sample stream. One or more service access ports may also be used to facilitate inspection, cleaning and maintenance of the system without the need for removal and possibly disassembly. The inlet port 10, liquid sample outlet 20 and/or vapor sample outlet 32 may be equipped with pressure regulation valves to facilitate embodiments that operate in pressure or vacuum service. In this embodiment, the temperature port 34 may also be equipped with a pressure gauge to manage system pressure.

At the end of the condensation circuit 30, after any separation orifice or nozzle, the liquid and vapor samples travel into the separation chamber, where the condensed and coalesced fluids, predominately liquids, are collected and removed from the sample chamber. The increase in velocity from the nozzle is directed to a downward curve of constant or decreasing radius utilizing centripetal and gravitational forces to separate the heavier liquid from lighter gases. The separated streams are then differentiated into a chamber of larger size than the sample path 18. Collected water removed at the liquid discharge port 20 may be collected either within or outside the apparatus, then sampled for further chemical analyses or disposed of from the system. In an alternate embodiment, a level indicator or moisture sensor may be placed inside the collection chamber, at the liquid discharge port, or outside the apparatus in a plurality of liquid collection systems to regulate a pump system that would transfer the collected fluids for further analysis or disposal. Once the vapor sample is separated from the removed liquids, the sample may be routed through another channel section to the vapor outlet port for further analysis. In another embodiment, the collected condensate may be routed through the vapor outlet port if separation is not required.

A temperature management system is included in the system to monitor sample channel or cold plate temperatures, allowing for external adjustment of the means of heat transfer. One or more temperature measurement devices may be placed in the sample stream at a plurality of locations within the cold plate 34, in a separate sample location outside the cold plate assembly, or in the body of the cold plate 36 to monitor cold plate temperature. Process logic external to the cold plate will control the temperature to optimize condensable liquid removal while preventing sample channel clogging due to vapor lock or ice crystallization.

The plate system consists of one or more bodies of solid heat exchange material, comprised of aluminum, steel, thermoplastic, glass, ceramic or other solid material capable of heat transfer. In the preferred embodiment, a two part sandwich of heat transfer capable solid materials, typically aluminum, is used, which allows access to the system to evaluate performance, corrosion, or the integrity of any channel coating material which may be applied to allow for increased flexibility in highly corrosive or eroding sample streams. The sandwich components in the typical embodiment are connected through a plurality of fasteners 38, which could include bolts, screws, clamps, thermoelastic sealants, chemical sealants or welded seams. These fasteners secure the airtight seal between layers 40, where the seal could include gaskets, rubber rings, thermoelastic sealant, caulk, or welded seams. As the system can be operated at a variety of angles, a plurality of mounting holes 42 secures the system to the external sampling system. Due to the solid nature of the housing, the system may condition fluid sample streams at any typical operating pressure, or under vacuum.

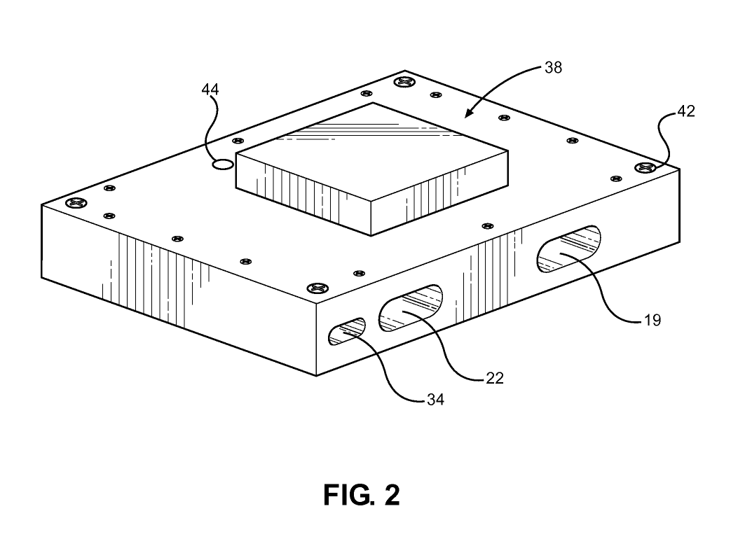

Referring now to FIG. 2, the sample inlet port 10, sample outlet port 22 and outlet thermo well 34 are shown in the typical embodiment on the same cold plate surface. Mounting and thermo well locations and shapes may vary to accommodate associated sampling and analysis equipment with which the cold plate will be integrated. A temperature management system is contained within the system 44. Temperature management may be accomplished in one of several ways. Basic operation of the sample preparation system includes a means to provide temperature control to allow condensable liquids in the channel to condense and coalesce along the channel walls.

A first alternative permits one or more additional channels in the cold plate to circulate a heat transfer fluid through the cold plate. A second alternative permits direct contact application of one or more cold plates to a plurality of sample cold plate surfaces, where heat transfer is provided by the contacted surface. A third alternative permits circulating air across a plurality of cold plate surfaces, with or without the use of heat transfer fins, plates or surface features adhered to a plurality of cold plate surfaces, to transfer heat across the surface of the cold plate using air or other gaseous heat transfer fluids. A fourth alternative permits adhering a Peltier thermoelectric heat transfer system to one or both sides of the cold plate. A fifth alternative embodiment allows multiple cooling elements on one or both sides of the assembly to better modulate sample stream temperature.

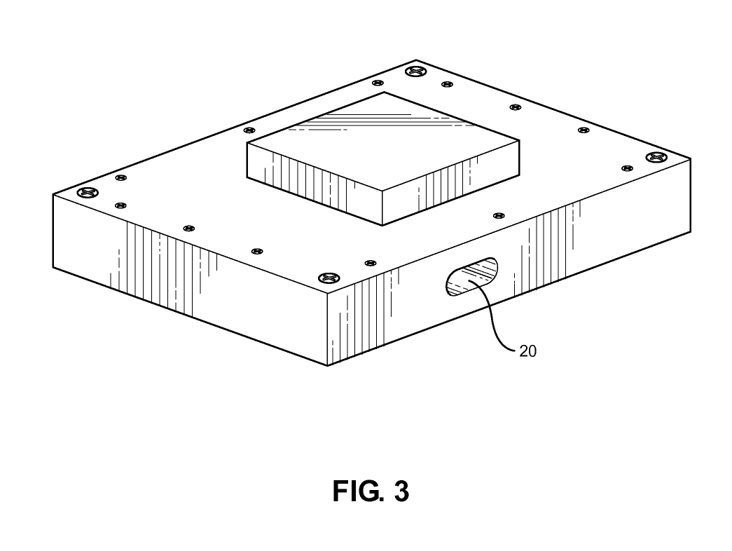

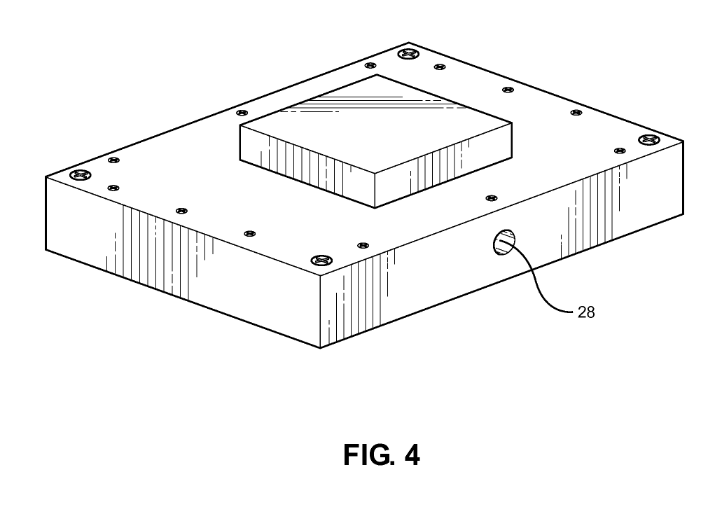

Referring now to FIG. 3, the typical embodiment includes the liquid sample outlet 20. The liquid sample outlet location and shape may vary to allow system integration. Referring now to FIG. 4, the typical embodiment includes one or more maintenance access points 28. The preferred embodiment includes a maintenance access port to service the separation orifice to accelerate flow across the path wall to create droplets, which could comprise a orifice ring, nozzle, or channel wall lip. Such an orifice could be fixed to the apparatus or removable. Additional embodiments include maintenance access ports at any other inlet or outlet access port location. Another preferred embodiment of the invention is the use of the described sample conditioners in series, where one conditioner removes certain liquids to a set temperature point, and one or more conditioner, set to a lower outlet temperature, removes additional vapors. An additional embodiment of the invention allows for one or more conditioners to be used in parallel, usable to route sample streams to different analyzers or to increase sample flow to a plurality of analyzers. Another embodiment includes additional taps throughout the sample stream to allow provision of wash materials to periodically clean the sample path, reducing maintenance downtime. An additional embodiment includes one or more conditioner systems in series, to either increase sample conditioning rates or allow samples to be collected at different temperatures to evaluate portions of the sampled gas stream.

Although this invention has been described in specific detail with reference to the disclosed embodiments, it will be understood that many variations and modifications may be effected within the spirit and scope of the invention as described in the appended claims.

I claim:

1. An apparatus for conditioning a fluid sample, comprising:
a fluid separator having an exterior housing that houses:
a vapor inlet port;
a first fluid path segment with a first and second end;
a second fluid path segment with a first and second end;
a third fluid path segment having a first and second end, and in fluid communication with a condensate collector chamber;
a condensate sample outlet port;
a fourth fluid path segment with a first and second end;
a vapor sample outlet port;
a plurality of cooling means; and
a means to monitor and control a heat transfer system electrically and operably coupled to said fluid separator and including one or more temperature sensors.

2. The apparatus of claim 1, wherein said exterior housing comprises two or more plates forming a hollow interior volume for housing interior components; wherein said plates are secured together via a fastening means.

3. The apparatus of claim 1, wherein said exterior housing comprises a solid block of one or more heat transfer material substances formed around housed components.

4. The apparatus of claim 1, wherein said sample inlet port is connected to said first end of said first fluid path segment; said second end of said first fluid path segment is connected to said first end of said second fluid path segment; said second end of said second fluid path segment is connected to the said first end of said third fluid path segment; said third fluid path segment is connected to said condensate outlet sample port; said second end of said third fluid path segment is connected to said first end of said fourth fluid path segment; and said second end of said fourth fluid path segment is connected to the vapor sample outlet port.

5. The apparatus of claim 1, wherein said sample inlet port is connected to said first end of said first fluid path segment; said second fluid path segment is connected to said first end of said second fluid path segment;
said second end of said second fluid path segment is connected to said first end of said third fluid path segment; said second end of said third fluid path segment is connected to said first end of said fourth fluid path segment; and said second end of said fourth fluid path segment is connected to the vapor sample outlet port.

6. The apparatus of claim 1, where said first fluid path segment condenses condensable matter.

7. The apparatus of claim 1, where said second fluid path segment forms condensate droplets.

8. The apparatus of claim 1, where said third fluid path segment separates condensed droplets from the fluid sample stream.

9. The apparatus of claim 1, where said fourth fluid path isolates the fluid sample stream from collected condensate and routes the fluid sample to the apparatus exit port.

10. The apparatus of claim 1, wherein a connection between said first fluid path segment and said second fluid path segment comprises a flow restriction.

11. The apparatus of claim 1, wherein a connection between said first fluid path segment and said second fluid path segment includes a maintenance port.

12. The apparatus of claim 1, wherein said third fluid path segment includes a liquid accumulation detection sensor.

13. The apparatus of claim 1, wherein one or more temperature sensors are included in said fourth fluid path segment and are configured to detect sample stream temperature.

14. The apparatus of claim 1, wherein one or more temperature sensors are coupled into said housing and are configured to detect housing temperature.

15. The apparatus of claim 1, wherein said cooling means includes a refrigeration path embedded in the body of said housing, and wherein said refrigeration path is hydraulically connected to an external heat exchange system.

16. The apparatus of claim 1, wherein said sample inlet port is equipped with a pressure regulator; and said condensate sample outlet port is equipped with a pressure regulator.

17. The apparatus of claim 16, wherein said sample outlet port is equipped with a pressure regulator.

18. The apparatus of claim 1, wherein said housing is constructed of heat transfer material.

19. The apparatus of claim 1, wherein said fourth fluid path segment includes a means to measure sample stream pressure.

20. The apparatus of claim 1, wherein said second fluid path segment is arcuate with increasing radius of curvature.

21. A system for conditioning fluid samples for sampling and analysis comprising:
one or more fluid separators:
one or more cooling means in communication with said one or more fluid separators;
a heat transfer system electrically and operably coupled to said one or more fluid separators and including one or more sensors; and
a means for controlling said heat transfer system electrically and operatively coupled to said heat transfer system and said one or more fluid separators.

22. The system of claim 21, where the heat transfer system causes condensable liquids, vapors, and particles to condense within said one or more fluid separators when in operation.

23. The system of claim 21, where the heat transfer system is set to a predetermined temperature based on a defined temperature set point associated with a target analyte to facilitate condensation at a defined temperature set point to facilitate condensation of designated fluid sample stream components.

24. The system of claim 21, where each of said one or more fluid separators comprises:
a fluid separator having an exterior housing that houses:
a vapor inlet port;
a first fluid path segment with a first and second end;
a second fluid path segment with a first and second end where the fluid path segment is curved with a constant radius;
a third fluid path segment, in fluid communication with a condensate collector chamber;
a condensate sample outlet port;
a fourth fluid path segment with a first and second end; and
a vapor sample outlet port.

25. The system of claim 21, wherein a plurality of said fluid separators are in fluid communication such that fluid samples pass from a fluid separator to fluid separator for treatment.

26. The system of claim 21, wherein said means for controlling said heat exchange system is configured to achieve designed sample condition at the sample fluid outlet port of the last sample conditioning system.

27. The system of claim 21, wherein said means for controlling said heat exchange system is configured to achieve designed sample condition to provide specific sample composition at each conditioning system outlet.

28. The system of claim 21, wherein said cooling means are configured to control housing temperature of one or more housings.

29. The system of claim 21, wherein said cooling means are configured to control path sample stream temperature.

30. A method to condition a fluid sample for chemical analysis, comprising:
inserting a fluid sample into a sample inlet port of a sample conditioner;
routing a fluid sample through a sample path inside a sample conditioner housing;
applying heat transfer to a sample conditioner housing to effect temperature change along said sample path;
condensing condensable matter onto side walls of said sample path;
separating condensable matter from said fluid sample stream;
collecting condensable matter within said sample path;
removing condensable matter from said sample path;
isolating said fluid sample stream from said condensable matter;
routing the fluid sample stream to a sample exit port; and
routing the fluid sample from the sample conditioner for further processing.

31. The method of claim 30, where heat transfer is applied by one or more heat transfer systems.

32. The method of claim 30, where sample stream temperature is controlled to a defined temperature set point to facilitate condensation of condensable sample constituents.

33. The method of claim 30, where one or more sample conditioners are operated in series, where each sample conditioner in series is controlled to a defined temperature set point to facilitate condensation of condensable sample constituents.
